(19) United States
(12) Patent Application Publication
(10) Pub. No.: US 2017/0181579 A1
(43) Pub. Date: Jun. 29, 2017

(54) A BARBECUE

(71) Applicant: Cengiz Guven ZEYBEK, Isparta (TR)

(72) Inventor: Cengiz Guven ZEYBEK, Isparta (TR)

(21) Appl. No.: 15/308,602

(22) PCT Filed: Apr. 20, 2015
(86) PCT No.: PCT/TR2015/000161

§ 371 Date: Nov. 2, 2016

(30) Foreign Application Priority Data
May 2, 2014 (TR) 2014/04940

(51) Int. Cl. A47J 37/07; F24B 3/00

(52) U.S. Cl. CPC A47J 37/0754; F24B 3/00

(57) ABSTRACT

The present invention relates to a barbecue (1) which enables the foods put thereon to be cooked, and essentially comprises at least one plate (2) comprising a blower therein, at least one body (3) located on the upper part of the plate (2), at least one inner chamber (4) placed on the inner part of the body (3), at least one burning chamber (5) in which the flammable materials are added, at least one cover (6) covering the upper part of the burning chamber (5), at least one upper air pipe (5.2) extending towards the cover (6) on the burning chamber (5) and enabling the air coming from a blower on the plate (2) to hit towards the cover (6), and protrusions (5.3) curved outwards the burning chamber (5) or inwards the burning chamber (5) so that the cover (6) stands still on the burning chamber (5).

### CROSS REFERENCE TO RELATED APPLICATIONS

This application is a national phase entry application of International Application NO. PCT/TR2015/000161, file on Apr. 20, 2015, which is based on and claims priority to NO. TR2014104940, file on May 2, 2014, the entire contents of which are incorporated herein by reference.

### TECHNICAL FILED

The present invention relates to a barbecue Which enables to perform cooking smoke. free.

### BACKGROUND

Barbecue is a mechanism which performs cooking by subjecting the meat, fish and vegetable directly to tire thereon, and increases the taste with its smoke. In present barbecues, the foods to be cooked on a gill are cooked with the coal burning under the grill. However, while cooking process is realized with these barbecues, a disturbing smoke is generated due to burning of the coal, and the grease of the cooked foods dropping on the burning coal.

There are barbecues with fans known in the state of the art. The enemy required for the fan in these products is met with the battery. The fans used in the barbecues blow air to the burning coal from below and ventilation process is enabled in this way.

Furthermore, the walls of the burning chambers are made from fine mesh sieve in several applications.

International Patent Document no WO2006053693 A1, an application known in the state of the art, discloses a method for heat control in barbecues. In the inventive method, burning charcoal is retained in an essentially closed burning chamber with at least one fine-mesh screen wall for the radiation of heat. In this heat source burning charcoal, an upper cover with fine meshed screen and a ventilation opening, an air supply channel opens into the lower part of the charcoal bowl, and an air flow generator such as fan can be connected to this part. In the invention, ventilation process with a fan is realized from the lower part of the charcoal bowl, heating process is realized from the sides with the fine meshed screen wall. In this embodiment, homogenous heat distribution is not provided in this state, the foods aligned at the edges of the upper grill are cooked later relative to the ones on the center.

In a product manufactured with brand name of Lotus Grill known in the state of the art, burning bowl is tine meshed, and heating and ventilation processes are realized through the openings on the walls of the burning bowl. A gel is burnt from the lower part of the burning bowl and the coal is ignited, and the heat generated as a result of burning goes out of the fine meshed sieve. However the lower coals burn in this barbecue and the upper coals do not fall towards the bottom, therefore the upper coals do not bum and intense smoke is generated. Therefore, an efficient burning is not realized and the upper unburnt coal should be dropped to the bottom by frequently hitting to the burning bowl. A fan operating with an alkaline battery is used under the outer body. However this fan only ventilates the coal burning on the bottom. Since the heat goes out from the side walls, homogenous heat distribution is not provided; the foods aligned at the edges of the upper grill are cooked later relative to the ones on the center.

### SUMMARY OF THE INVENTION

The objective of the present invention is to provide a barbecue which does not harm the environment, eliminates oil waste, performs more cooking with less fuel, and which also performs cooking smoke free.

Another objective of the present invention is to provide a barbecue which performs a more effective cooking process with a blower therein and a button for adjusting the speed of the blower and control of the flame.

A further objective of the present invention is to provide a barbecue which enables to guide the flame downwards by means of the upper ventilation pipe extending towards the cover of the burning chamber and the cover attached to the upper part of the burning Chamber together with the protrusion and openings located on the upper part. of the burning chamber, and the heat hitting to the walls of the inner chamber to cook the foods on the grill homogeneously.

Yet another objective of the present invention is to provide a barbecue the air movement of which is enabled with a blower which can be fed through the electrical network or car battery or a battery.

Another objective of the present invention is to provide a barbecue which enables to perform efficient and equally distributed burning process by means of the holes and the curve on the burning chamber.

A further objective of the present invention is to provide a barbecue which performs cooking in a two folded way by means of the lower gill.

### BRIEF DESCRIPTION OF THE DRAWINGS

A barbecue developed to fulfill the objectives of the present invention is illustrated in the accompanying figures, in which:

FIG. 1 is the exploded view of the inventive barbecue.

FIG. 2 is the perspective view of the plate.

FIG. 3 is the perspective view of the body.

FIG. 4 is the perspective view of the inner chamber.

FIG. 5 is the perspective view of the cover.

FIG. 6 is the perspective view of the water reservoir.

FIG. 7 is the perspective view of burning chamber having straight protrusions.

FIG. 8 is the perspective view of a burning chamber having protrusions bent outwardly used in a preferred embodiment of the invention.

FIG. 9 is the perspective view of upper pill and inner chamber.

FIG. 10 is the perspective view of burning chamber, lower grill and inner chamber.

FIG. 11 is the perspective view of the tongs and the burning chamber.

FIG. 12 is the perspective view of inner chamber used in one embodiment of the invention and the bearing therein.

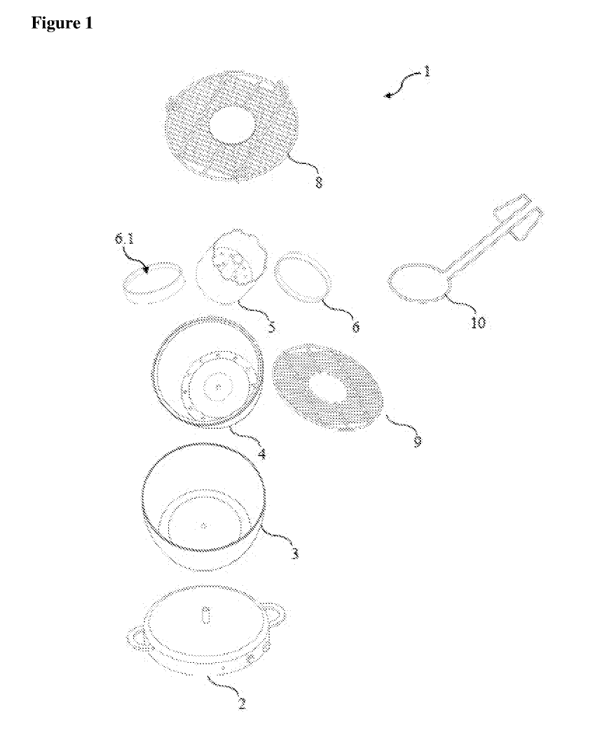

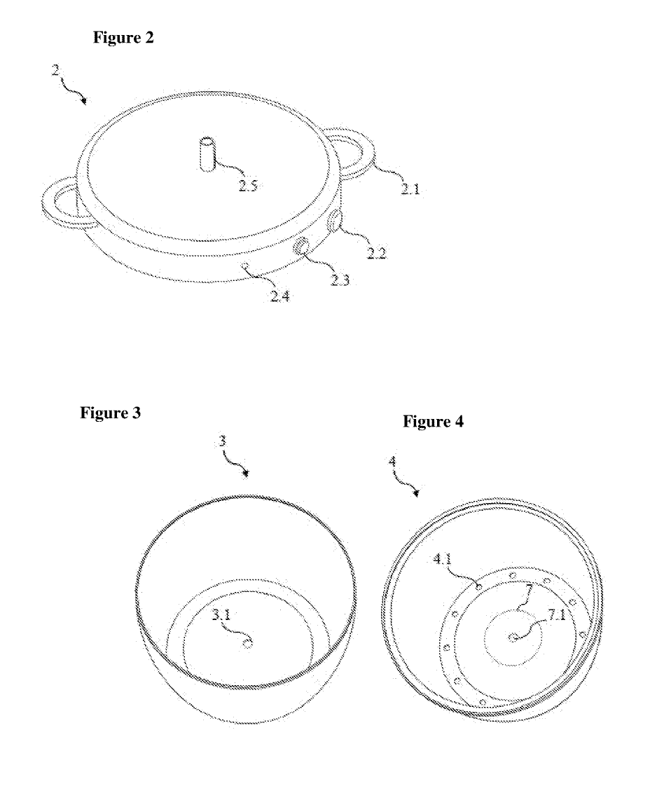

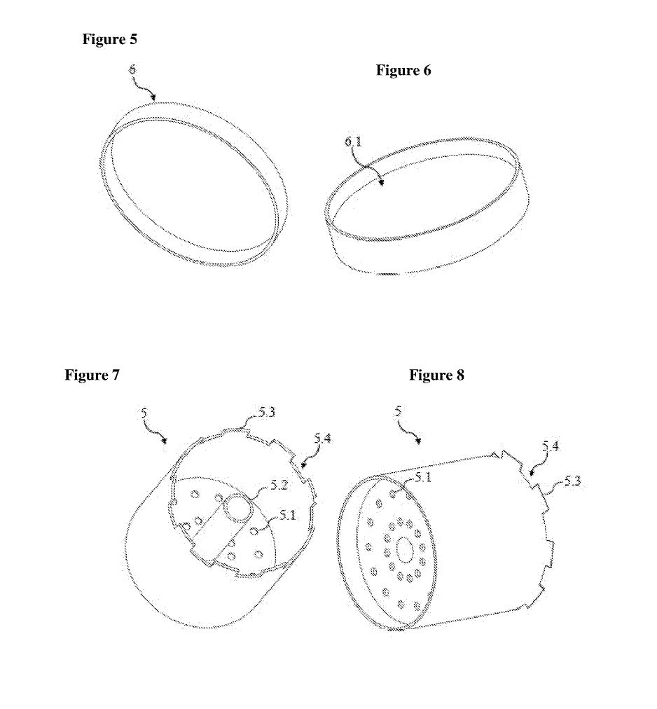

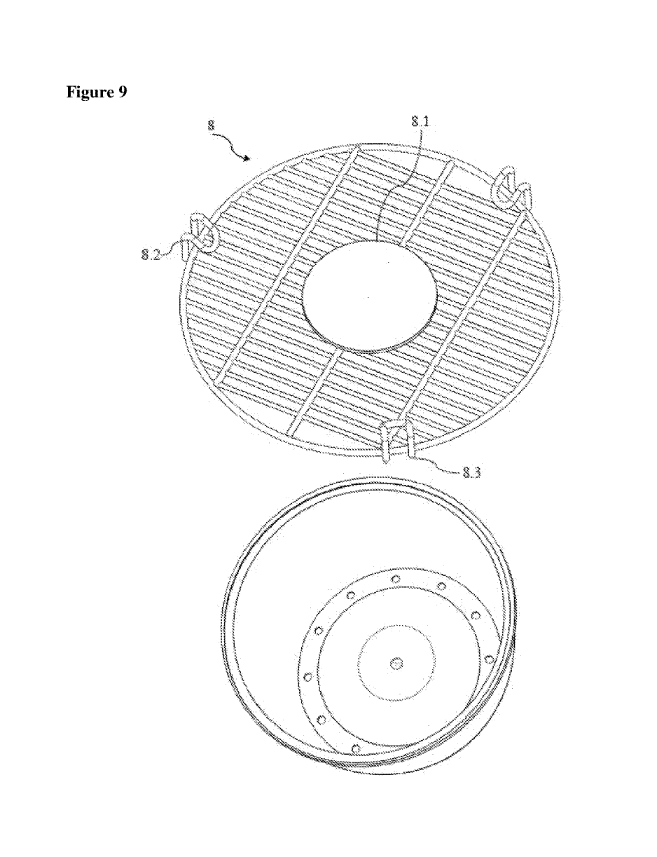

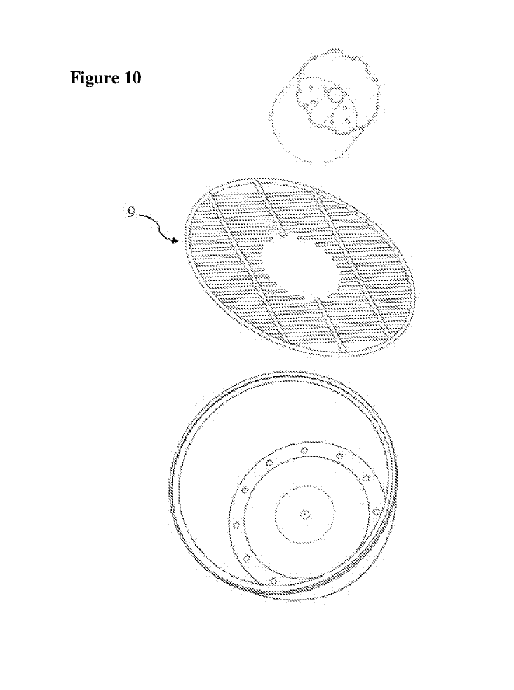

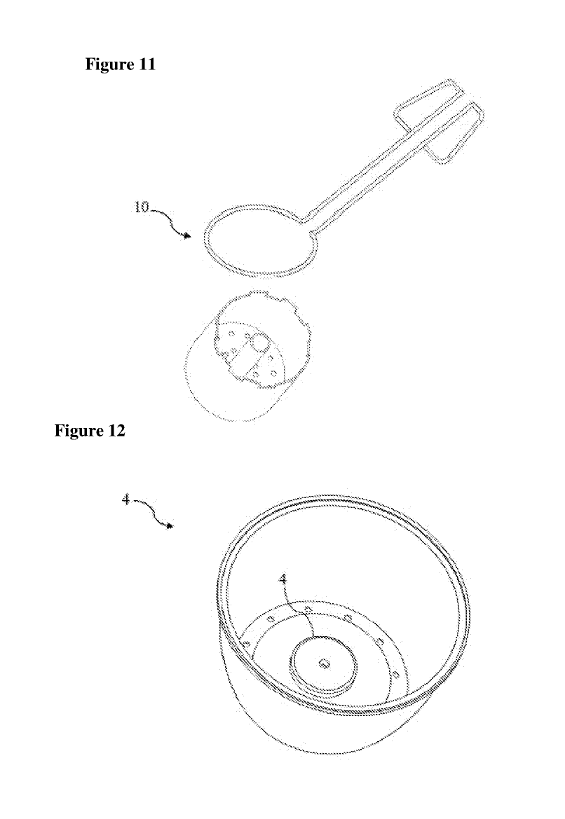

The components shown in the figures are each given reference numbers as follows:

1. Barbecue

2. Plate
2.1. Handle
2.2. Power switch
2.3. Adjusting switch
2.4. Adapter inlet

3. Lower air pipe Body
3.1. First air hole

4. Inner chamber
4.1. Oil discharge hole

5. Burning chamber
5.1. Ventilation bole
5.2. Upper air pipe
5.3. Protrusion
5.4. Opening

6. Cover
6.1. Water reservoir

7. Bearing
7.1. Second air hole

8. Upper grill
8.1. Oil protector
8.2. Curved foot
8.3. Extension

9. Lower grill

10. Tongs

### DETAILED DESCRIPTION

Inventive barbecue (1) which enables the foods put thereon to be cooked smoke free comprises
at least one plate (2) which comprises a blower therein,
at least two handles (2.1) which are preferably located on the side wall of plate (2) and enable plate (2) to be lifted while carrying it where it is desired,
at least one power switch (2.2) which is preferably located on the side wall of plate (2) and enables the blower (fan) inside plate (2) to be turned on and off
at least one adjusting switch (2.3) which is preferably located on the side wall of plate (2) and enables the speed of the blower (fan) inside plate (2) to be adjusted,
at least one adapter, inlet (2.4) in which the cable tip of an adapter, enabling to transform the level of electric energy coming from electrical network or car battery to levels in which the blower (fan) inside plate (2) can work, can enter,
at least one lower air pipe (2.5) which is preferably located on the upper part of plate (2) and enables air passage coining from a blower inside plate (2),
at least one body (3) which is placed on the upper part of plate (2),
at least one first air hole (3.1) which is located on the inner part of body (3) and which has the diameter on which lower air pipe (2.5) can engage through it,
at least one inner chamber (4) which is located in the inner part of body (3),
at least one oil discharge hole (4.1) which is made preferably on the base of inner chamber (4) so that the oil dropping from the cooked foods is transferred to body (3) on the bottom,
at least one burning chamber (5) in which flammable materials are added,
at least one ventilation hole (5.1) which is made on the base of burning chamber (5),
at least one upper air pipe (5.2) which is located inside burning chamber (5) and enables air passage coming from a blower inside plate (5),
at least two protrusions (5.3) which are located on the upper part of burning chamber (5),
at least one opening (5.4) which is located between protrusions (5.3) present on the upper part of burning chamber (5), and which enables the heat coming from the burning materials to go outside,
at least one cover (6) which covers the top part of burning chamber (5),
at least one water reservoir (6.1) which is located on cover (6) and in which a liquid can be put,
at least one bearing (7) which is preferably in the inner part of inner chamber (4), and prevents burning chamber (5) from moving by fitting burning chamber (5) on it,
at least one second air hole (7.1) which is made on, bearing (7) and enables the passage of the air coming from lower air pipe (2.5),
at least one upper grill (8) on which the foods to be cooked are placed,
at least one oil protector (8.1) which prevents the oil dropping from the cooked foods to drip on cover (6) on burning chamber (5),
at least two curved feet (8.2) which are preferably positioned around upper grill (8), and which provides support to a heating means in order to heat the heating means such as sheet metal in the coal fire,
at least one extension (8.3) which prevents upper grill (8) from moving horizontally by extending towards plate (2) from the upper part of curved foot (8.2),
at least one lower grill (9) which is located between upper grill (8) and the base of inner chamber (4),
at least one tong (10) which enables burning chamber (5) to be held,

In a preferred embodiment of inventive barbecue (1), there is plate (2). There are at least two handles (2.1) enabling barbecue (1) to be carried on a preferred place, for example its side parts.

There is a blower (not shown in the figures) blowing air in the inner part of plate (2). In the preferred embodiment of the invention, the blower can work with one or a plurality of batteries/rechargeable batteries placed in a compartment positioned on the lower part of plate (2). In another embodiment of the invention, there is adapter inlet (2.4) in which an adapter cable tip can enter preferably on the side wall of plate (2). Network electric is reduced to the voltage range in which the blower can work by means of the adapter. In another embodiment of the invention, necessary electric energy is received from lighter of a motor vehicle via an adapter, and it is reduced to a voltage range in which the blower can work, and thus the blower can be worked with car battery. In one embodiment of the invention, the adapted can be an adapted such as mobile phone charger, and a rechargeable battery inside plate (2) can be charged. In another embodiment of the invention, it can directly reduce the electricity to the desired voltage levels like an adapter of a laptop computer. In another embodiment of the invention, the adapter is located inside plate (2), and the cable of this adapter preferably goes out of the side wall of plate (2) and it can be plugged into the lighter of the vehicle or the plug socket.

After the electric energy required for the operation of the blower inside plate (2) is supplied, power switch (2.2) enabling the blower to operate is turned on. In one embodiment of the invention, power switch (2.2) is provided on the side wall of plate (2).

After the blower inside plate (2) is turned on, the air blowing level of the blower can be adjusted via an adjusting switch (2.3). Adjusting switch (2.3) has a plurality of levels. The level of adjusting switch (2.3) is decreased and increased, and thus the food can be cooked faster or slower.

On the upper part of plate (2), here is lower air pipe (2.5) which extends upwards and enables the air generated via the blower inside plate (2) to pass towards burning chamber (5) present in inner part of the body (3).

Inventive barbecue (1) has body (3). The temperature of the outer wall of body (3) is manufactured from a material which does not burn the user's hand while barbecue (1) is burning. In one embodiment of the invention, the diameter of this body (3) increases by moving from bottom to the top of body (3). There is a first air hole (3.1) on the upper part, preferably at the center, of plate (2). The diameter of first air hole (3.1) is large enough so that lower air pipe (2.5) extending from the middle part of plate (2) can pass through.

inner chamber (4) having an approximately same size with body (3) is placed inside the body (3). A plurality of oil discharge holes (4.1) are placed preferably on the base of inner chamber (4). Oil discharge holes (4.1) enables the oil dropping from the cooked foods to be collected in body (3) located on the lower part of inner chamber (4). Furthermore, inner chamber (4) can be filled with water, and thus the oil dropping from the cooked foods is enabled to be transferred to body (3) more easily. Therefore, the oils are prevented from sticking to inner chamber (4), and the smoke and the smell due to burning of the oil is avoided.

There is binning chamber (5) on the upper part of inner chamber (4). Burning chamber (5) can be manufactured from a material such as chromium nickel resistant to high temperatures. Solid fuels such as wood or coal are put inside burning chamber (5) in order to cook the foods.

A plurality of ventilation holes (5.1) are made on the base of burning chamber (5). Ventilation holes (5.1) enable the fuels in burning chamber (5) to be aerated from the below.

There is upper air pipe (5.2) extending upwards preferably from the base part of the binning chamber (5), inside burning chamber (5). Upper air pipe (5.2) enables the air generated by a blower inside plate (2) and coming from lower air pipe (2.5) to pass inside burning chamber (5).

In one embodiment of the invention, upper air pipe (5.2) can be a single pipe instead of two pipes such as lower air pipe (2.5) and upper air pipe (5.2), and transfer the air coming from the blower to burning chamber (5). The pipe can be directly connected to the blower. In another embodiment of the invention, the it can be a cable which can easily be attached to the inlet of the blower.

There are protrusions (5.3) on the upper parts of the walls of burning chamber (5). There is opening (5.4) between each two protrusions (5.3). By means of these openings (5.4), the heat and flame generated by the fuels in burning chamber (5) are enabled to go out of burning chamber (5).

The upper part of burning chamber (5) is covered via cover (6). The diameter of cover (6) is a little larger than the diameter of burning chamber (5). In one embodiment of the invention, protrusions (53) on burning chamber (5) can be preferably curved outwards burning chamber (5) or inwards burning chamber (5) in order that cover (6) remains fixed on burning chamber (5) (not shown in figures).

In one embodiment of the invention, on the upper part of cover (6), there is water reservoir (6.1) preferably integrated with this cover (6) and having nearly the same sizes, but looking upwards contrarily. Water is filled in water reservoir (6.1) and it is enabled to evaporate during cooking, thus steam cooking is performed. In another embodiment of the invention, the oil dripping from foods put in the middle of upper grill (8) without oil protector (8.1) is enabled to drop inside water reservoir (6.1). Therefore, the oil dripping from the foods placed on upper grill (8) drops on the water filled inside water reservoir (8.1) instead of dropping on cover (6) of burning chamber (5), and thus the smoke due to the oil dripping and burning on cover (6) of burning chamber (5) is avoided.

There is bearing (7) so that burning chamber (5) does not move on inner chamber (4) and fall over. In one embodiment of the invention, bearing (7) is fixed on the inner chamber (4). Bearing (7) enters into a space present on the lower part of burning chamber (5) and thus burning chamber (5) is prevented from moving. Bearing (7) extends from the base of inner chamber (4) upwards in a curved way (not shown in figures). Therefore, a level difference is created between burning chamber (5) and—inner chamber (4), and the oil filling into the base of inner chamber (4) is prevented from reaching second air hole (7.1) on bearing (7). In one embodiment of the invention, bearing (7) extends from the base of inner chamber (4) upwards in shape of a protrusion (FIG. 12).

There is second air hole (7.1) made in the middle part of bearing (7). The air coming from lower air pipe (2.5) is enabled to pass to an opening between bearing (7) and burning chamber (5) by means of second air hole (7.1). Therefore, some part of the air coming from second air hole (7.1) enters into upper air pipe (5.2) in burning chamber (5), and the other part enters through ventilation holes (5.1) on the lower part of burning chamber (5), and the fuels placed on the base of burning chamber (5) are enabled to be aerated.

Upper grill (8) is placed on upper part of the body (3), and the foods to be cooked are placed on upper grill (8). In the middle part of upper grill (8), there is oil protector (8.1) which has nearly the same sizes with cover (6) on burning chamber (5) or which is a little larger than it. By means of oil protector (8.1), the oil dripping from the foods cooking on upper grill (8) is prevented from dropping on cover (6) on the upper part of burning chamber (5), and thus the smoke due to burning of oil is eliminated.

There are a plurality of curved feet (8.2) preferably positioned around upper grill (8). enabling upper grill (8) to be carried easily, and providing support for heating a heating means such as sheet metal on the coal; and there are extensions (8.3) extending towards plate (2) on the lower part of curved feet (8.2). Some part of—extensions (8.3) is integrated with body (3), and thus upper grill (8) is prevented from moving horizontally on body (3).

In one embodiment of the invention, there is lower grill (9) which can be placed between upper grill (8) and the base of inner chamber (4). The other foods wanted to be cooked can be placed on lower mill (9). There is an opening in the middle part of—lower grill (9). The width of this opening is nearly as much as the diameter of burning chamber (5). In one embodiment of the invention, the diameter of inner chamber (4) decreases from top to bottom, therefore lower grill (9) can remain fixed by being supported by the walls of inner chamber (4) which has the same diameter with itself.

In invention, tong (10) is also used which enables burning chamber (5) to be carried while it is hot. The part of tong (10) holding burning chamber (5) has a circular Shape. which is compatible with the cylindrical structure of the burning chamber. A space is formed on stem part of the tong through which the fingers can pass. The user can easily pass their fingers through this space and hold tong (10), and move these bars to each other and apply force on the outer wall of burning chamber (5) by narrowing circle, and they can easily carry burning chamber (5).

An operating principle in one embodiment of inventive barbecue (1) is as follows:

Lower air pipe (2.5) extending upwards from plate (2) is first passed through first air hole (3.1) on body (3), and body (3) is placed on plate (2), and inner chamber (4) is directly placed in the inner part of body (3). Burning chamber (5) is placed on bearing (7) in the inner part of inner chamber (4) such that it will enter into an opening in the lower part.

In one embodiment of the invention, if lower gill (9) will be used, burning chamber (5) is passed through the opening in the middle of lower grill (9), and it is placed on—bearing (7).

The solid materials such as wood, coal which can burn inside burning chamber (5) are placed, and wood or coal are ignited from their upper surfaces. A gel or kindling wood can be used for ignition. After this process, cover (6) is covered on the upper part of burning chamber (5) and power switch (2.2) is turned on, and thus the blower inside plate (2) is operated. In one embodiment of the invention, the energy required for the blower to operate is provided via the batteries present on the lower part of plate (2), whereas in another embodiment of the invention, it is enabled to decrease the electric coming from the electric network to levels in which the blower can work or to transform the energy coining from the car battery to suitable levels via an adapter. The air blowing level of the blower can be increased or decreased with adjusting switch (2.3). Upper grill (8) is placed on body (3) and the foods to be cooked are put on upper grill (8).

Lower air pipe (2.5) guides the air coming from a blower inside plate (2) to the part between bearing (7) and burning chamber (5). Some part of this air passes through ventilation holes (5.1) present on the lower part of burning chamber (5.1) and enables the fuels on the base of burning chamber (5) to be aerated. The other part of the air coming from the blower inside plate (2) is enabled to hit towards cover (6) via upper air pipe (5.2) located inside burning chamber (5) and extending towards cover (6). Some part of the air hitting to the cover (6) turns back towards the burning fuels. inside the burning chamber (5), and the other part goes outside through openings (5.4) between protrusions (5.3) present on the upper part of burning chamber (5). The heated air going outside hits the inner walls of inner chamber (4) with the effect of the pressurized air coming out of the blower and raises upwards, and thus the foods on upper grill (8) are enabled to be cooked homogeneously. The unburnt gases coming out with the flame from burning chamber (5) burn with the movement of the air during this process.

Since the oil of the cooked foods does not drip on cover (6) covering, burning chamber (5) by means of oil protector (8.1) on upper grill (8), no smoke is generated due to burning of the oil. The oil dropping from the cooked foods is transferred to body (3) present on the bottom through oil discharge holes (4.1) made on the base of inner chamber (4).

In one embodiment of the invention, by means of water reservoir (6.1) present on cover (6). steam cooking can also be performed as a result of the evaporated water filled inside water reservoir (6.1).

In another embodiment of the invention, the oil dripping from foods put in the middle of upper grill (8) without oil protector (8.1) is enabled to drop inside water reservoir (6.1) in which water is filled. Therefore, the oil dripping drops on the water filled inside water reservoir (6.1) instead of dropping on cover (6) of hot burning chamber (5), and thus the smoke due to the oil dripping and burning on the cover (6) of burning chamber (5) is avoided.

After cooking is completed, burning chamber is held with tong (10), and hot burning chamber (5) can easily be removed from its place.

1. A barbecue, which enables the food put thereon to be cooked, comprising
at least one plate which comprises a blower therein,
at least one body which is placed on the upper part of the plate,
at least one burning chamber in which flammable materials are added,
at least one cover which covers the top part of the burning chamber, and wherein
at least one upper air pipe which extends towards the cover on the burning chamber and enables the air coming from a blower on the plate to hit towards the cover.

2. The barbecue according to claim 1, wherein at least two protrusions which are located on the upper part of the burning chamber.

3. The barbecue according to claim 2, wherein protrusions which are curved outwards the burning chamber or inwards the burning chamber so that the cover stands still on the burning chamber.

4. The barbecue according to claim 2, wherein at least one opening which is located between the protrusions present on the upper part of the burning chamber, and which enables the heat coming from the burning materials to go outside.

5. The barbecue according to claim 1, wherein at least one ventilation hole which is made on the base of the burning chamber and enables the inflammable material inside the burning chamber to be aerated.

6. The barbecue according to claim 1, wherein an inner chamber which is placed in the inner part of the body.

7. The barbecue according to any claim 1, wherein at least one oil discharge hole which is made preferably on the base of the inner chamber so that the oil dropping from the cooked foods is transferred to the body on the bottom.

8. The barbecue according to claim 1, wherein at least one water reservoir which is located on the cover and in which a liquid is put.

9. The barbecue according to claim 1, wherein at least two handles which are preferably located on the side wall of the plate and enable the plate to be lifted while carrying it where it is desired.

10. The barbecue according to claim 1, wherein at least one power switch which is preferably located on the side wall of the plate and enables a blower inside the plate to be turned on and off.

11. The barbecue according to claim 1, wherein at least one adjusting switch which is preferably located on the side wall of the plate and enables the speed of the blower inside the plate to be adjusted.

12. The barbecue according to claim 1, wherein at least one adapter inlet in which the cable tip of an adapter, enabling to transform the level of electric energy coming from electrical network or car battery to levels in which the blower inside the plate is work, is enter.

13. The barbecue according to claim 1, wherein one or a plurality of batteries/rechargeable batteries which are placed inside a compartment positioned on the lower part of the plate.

14. The barbecue according to claim 1, wherein at least one bearing which is preferably in the inner part of the inner chamber, and prevents the burning chamber from moving by fitting the burning chamber on it.

15. The barbecue according to claim 1, wherein at least one lower air pipe which is preferably located on the upper part of the plate and enables air coming from a blower inside the plate to be filled into a compartment between the bearing and the burning chamber.

16. The barbecue according to claim 1, wherein at least one first air hole which is located on the inner part of the body and which has the diameter through which the lower air pipe is passed.

17. The barbecue according to claim 1, wherein at least one upper air pipe which is a single pipe instead of two pipes such as lower air pipe and upper air pipe, and transfers the air coming from the blower to the burning chamber.

18. The barbecue according to claim 16, wherein at least one second air hole which is made on the center of the bearing and enables the air coming from the lower air pipe to pass to an opening between the bearing and the burning chamber.

19. The barbecue according to claim 1, wherein an upper grill on which the foods to be cooked are placed.

20. The barbecue according to claim 19, wherein at least one oil protector which is located on the middle part of the upper grill, which as nearly the same sizes with the cover on the burning chamber, and which prevents the oil dropping from foods cooked on the upper grill to drip on the cover on the burning chamber.

21. The barbecue according to claim 19, wherein at least two curved feet which are preferably positioned around the upper grill, and which provides support to a heating means in order to heat the heating means such as sheet metal in the coal fire.

22. The barbecue according to claim 21, wherein at least one extension which prevents the upper grill from moving horizontally by extending towards the plate from the upper part of the curved foot.

23. The barbecue according to claim 1, wherein a lower grill which is located between the upper grill and the inner chamber, and which has an opening in the middle having nearly the same diameter of the burning chamber.

24. The barbecue according to claim 1, wherein a tong which enables the hot burning chamber to be carried, the part of which holding the burning chamber is in a circular form compatible with the cylindrical structure of the burning chamber, and the stem part of which has an opening in which the fingers can pass through.
